(19) United States
(12) Patent Application Publication
(10) Pub. No.: US 2020/0101857 A1
(43) Pub. Date: Apr. 2, 2020

(54) WIND TURBINE FOR ELECTRIC VEHICLES

(71) Applicant: David Christopher Venable, Troy, MI (US)

(72) Inventor: David Christopher Venable, Troy, MI (US)

(21) Appl. No.: 16/585,448

(22) Filed: Sep. 27, 2019

Related U.S. Application Data
(60) Provisional application No. 62/739,497, filed on Oct. 1, 2018.

(51) Int. Cl. B60L 53/52; F03D 9/32

(52) U.S. Cl. CPC B60L 53/52; B60L 8/006; F03D 9/32

(57) ABSTRACT

A system and apparatus having a wind turbine used in connection with an electric vehicle configured to supply supplemental power to a battery so as to extend the battery life of an electric vehicle. The apparatus includes a flow director or air foil configured to direct air to at least one twisted savonius turbine. The present apparatus, method of use and system details utilization of said air into a wind turbine connected to a vehicle. The turbine is configured to generate electricity which is in turn fed back into the vehicle's battery system. Use of the wind turbine as described herein is configured to extend the battery life of an electric vehicle thereby increasing the range, as measured by distance traveled, between battery recharges.

### CROSS REFERENCE TO RELATED APPLICATIONS

The application claims priority and benefit to U.S. provisional application Ser. No. 62/739,497 filed on Oct. 1, 2018 which is incorporated herein by reference.

### TECHNICAL FIELD

The present specification generally relates to power generating means for electric vehicles and, more specifically, a wind turbine and corresponding body structure for use in connection with an electric vehicle.

### BACKGROUND

Electric vehicles are well known in the art. Electric vehicles use one or more electric motors or traction motors for propulsion. An electric vehicle may be powered through a collector system by electricity from off-vehicle sources, or may be self-contained with a battery to convert fuel to electricity. Electric vehicles include, but are not limited to, road and rail vehicles, surface and underwater vessels, electric aircraft and electric spacecraft. Most electric vehicles use some form of lithium ion batteries. Lithium ion batteries have higher energy density, longer life span and higher power density than most other practical batteries. Complicating factors include safety, durability, thermal breakdown and cost. The downside to using Lithium ion batteries is that their lifespan is capped while operating the vehicle.

Accordingly, a need exists for an improved system, method and apparatus for providing a supply of power to a vehicle so as to extend the overall battery life of the electric vehicle.

### SUMMARY

The apparatus, method of use and system described herein discloses a wind turbine used in connection with an electric vehicle configured to supply supplemental power to a battery so as to extend the battery life of an electric vehicle. The apparatus includes a flow director or air foil configured to direct air to at least one twisted savonius turbine. The present apparatus, method of use and system details utilization of said air into a wind turbine connected to a vehicle. The turbine is configured to generate electricity which is in turn fed back into the vehicle's battery system. Use of the wind turbine as described herein is configured to extend the battery life of an electric vehicle thereby increasing the range, as measured by distance traveled, between battery recharges.

A system for harnessing wind energy in a vehicle, the vehicle having a body, the system including at least one flow director connected to the vehicle and at least one savonius turbine connected to the vehicle, the at least one flow director configured to direct air towards the at least one savonius turbine, the at least one savonius turbine connected to an energy storage device wherein the savonius turbine harnesses wind energy created by a vehicle in motion, wherein movement of the savonius turbine generates power which is stored in the energy storage device. In one embodiment, two of the at least one savonius turbine are positioned at towards the rear of the vehicle, the savonius turbines positioned on opposed sides of the vehicle. Two of the at least one flow directors may be positioned on outer opposed corners of the vehicle, an opening positioned in the body of the vehicle so as to direct air into a cavity so as to rotate the two of the at least one savonius turbines. In some embodiments, the at least one savonius turbine is positioned at the rear of a vehicle within and adjacent to an opening in the body of the vehicle. In other embodiments, the opening spans the width of the vehicle.

In some embodiments, the flow direct is positioned adjacent the opening, the flow director positioned on an underside of the vehicle, the flow director spanning the width of the vehicle. In this embodiment, the at least one savonius turbine is positioned within the opening on the underside of the vehicle.

In other embodiments, the flow director is positioned on or adjacent to the hood of the vehicle. In this embodiment, the air flow director spans the width of the vehicle. An opening may contain the at least one savonius turbine, the air flow director is configured to direct air from the vehicle in motion to the at least one savonius turbine positioned within the opening.

In other embodiments, each of the at least one savonius turbines includes two spaced apart blades connected by a central axis of rotation, each of the blades including a curved distal end. In some embodiments, each of the at least savonius turbines is helical.

In an alternative embodiment, the air flow director is positioned on a front corner of the vehicle, the air flow director having an opening and an exit so as to allow air to pass through while the vehicle is in motion. In this embodiment, the at least one savonius turbine is positioned within the opening.

In other embodiments, an opening is positioned on a side panel of a vehicle, the opening positioned forward of the vehicle tire. In this embodiment, a cavity is positioned above the vehicle tire, the at least one savonius turbine positioned rear of the vehicle tire and in fluid communication with the opening positioned forward of the tire.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an elevational view of the present system as applied to a trailer according to one or more embodiments shown and described herein;

FIG. 2 depicts a front view of the present system depicting airflow movement according to one or more embodiments shown and described herein;

FIG. 3 depicts an elevational view illustrating airflow through the turbines connected to a trailer of a vehicle according to one or more embodiments shown and described herein;

FIG. 4 depicts a front view of the turbines and airflow movement according to one or more embodiments shown and described herein;

FIG. 5 depicts an elevational view of a vehicle application of the present system according to one or more embodiments shown and described herein;

FIG. 6 depicts a front view of a vehicle application using the present system according to one or more embodiments shown and described herein;

FIG. 7 depicts an elevational view of the system as applied to a vehicle illustrating airflow through the turbines according to one or more embodiments shown and described herein;

FIG. 8 depicts a front view of the turbines connected to a vehicle of the present system according to one or more embodiments shown and described herein;

FIG. 9 depicts an alternative vehicle application of a bottom up view of a vehicle utilizing the present system according to one or more embodiments shown and described herein;

FIG. 10 depicts a side view of the alternative embodiment depicted in FIG. 9 illustrating airflow and the opening to the wind turbine as applied to a vehicle of the present system according to one or more embodiments shown and described herein;

FIG. 11 depicts a bottom view of the alternative vehicle application as shown in FIG. 9 illustrating wind turbine placement of the present system according to one or more embodiments shown and described herein;

FIG. 12 illustrates a side view of the alternative embodiment as illustrated in FIG. 9 illustrating placement of the wind turbine in corresponding airflow of the system according to one or more embodiments shown and described herein;

FIG. 13 depicts yet another alternative embodiment of the system as applied to a vehicle in an elevational view configuration using the present system according to one or more embodiments shown and described herein;

FIG. 14 depicts the vehicle of the alternative embodiment of FIG. 13 from a side view illustrating airflow at the front of the vehicle according to one or more embodiments shown and described herein;

FIG. 15 depicts the alternative embodiment of FIG. 13 from a elevational view depicting the locations of the wind turbines according to one or more embodiments shown and described herein;

FIG. 16 depicts the alternative embodiment as shown in FIG. 13 from a side view illustrating position of the wind turbines and corresponding airflow of the system according to one or more embodiments shown and described herein;

FIG. 17 depicts yet another alternative embodiment of a truck illustrating a rear view of the wind turbines of the present system according to one or more embodiments shown and described herein;

FIG. 18 depicts a side view of the truck depicting airflow of the present system according to one or more embodiments shown and described herein;

FIG. 19 depicts a singular wind turbine in an exemplary format used in any of the embodiments discussed and illustrated in this specification according to one or more embodiments shown and described herein;

FIG. 20 depicts a elevational view of the wind turbine and corresponding rotational movement as applied to the present system according to one or more embodiments shown and described herein;

FIG. 21 depicts an alternative horizontal orientation wind turbine which may be applied to any of the present systems and embodiments within this specification according to one or more embodiments shown and described herein;

FIG. 22 depicts an alternative embodiment of an inlet and an outlet allowing wind to access the turbine according to one or more embodiments shown and described herein; and

FIG. 23 depicts yet another alternative embodiment of an inlet and an outlet allowing wind to access the turbine according to one or more embodiments shown and described herein.

### DETAILED DESCRIPTION

The present apparatus, method of use and system relate to a wind turbine system and method for use with electric vehicles. A vehicle in motion dictates that it must push through and displace air around a vehicle while the vehicle is in motion. Accordingly, the present specification details utilization of said air into a wind turbine connected to a vehicle. The turbine is configured to generate electricity which is in turn fed back into the vehicle's battery system. Use of the wind turbine as described herein is configured to extend the battery life of an electric vehicle thereby increasing the range as measured by distance traveled between battery recharges.

Using the Coanda effect to channel the air displaced by the electric vehicle as it moves, air is channeled into a twisted savonius wind turbine that converts mechanical energy into electricity via an alternator. The electricity generated by the turbine via the alternator is then fed into the electric vehicles battery system, effectively charging the battery system while the vehicle is in motion.

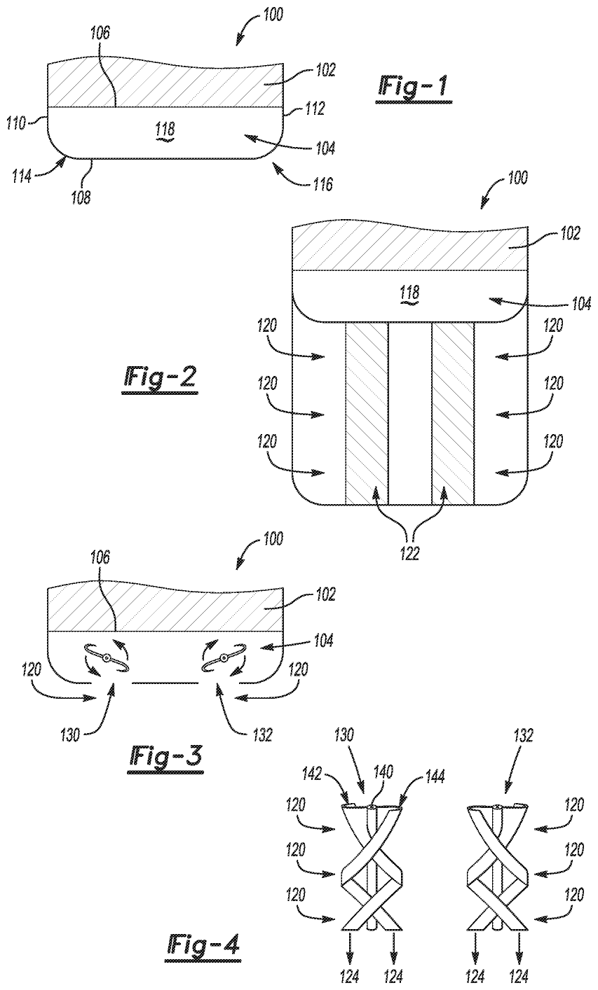

Referring now to FIGS. 1-4, a first exemplary embodiment is depicted where the system is applied to a trailer or rear of an electric vehicle. The system 100 includes a trailer 102 with a housing 104 connected thereto. The housing 104 is configured to contain the wind turbines 130, 132. The housing 104 is further configured to act as an airfoil to direct the air 120 as the vehicle is in motion. The housing 104 generally includes an upper surface 118 which, in this configuration, is solid. The housing 104 further includes curved edges 114, 116 which utilize the Coanda effect to channel air into the wind turbine contained within the housing 104. The housing 104 further includes opposed sidewalls 110, 112 which connect to the trailer as well as opposed sidewalls 106, 108 where sidewall 106 connects directly to the trailer 102. The surfaces of the housing 104 may be smooth or textured so as to promote or encourage airflow in specific areas. The housing 104 includes openings 122 configured to accommodate the wind turbines.

The wind turbines 130, 132 are twisted savonius wind turbines and are arranged in a vertical fashion. Each of the wind turbines 130, 132 includes a main central axis of rotation 140 and corresponding twisted wing elements 142, 144. The specific angles of curvature and dimensions may vary according to the needs of the turbine system and of the power required by the battery of the vehicle. Airflow 120 passes around the trailer and the housing 104 around the curved edges 114, 116. Airflow 120 is directed to the turbines 130, 132 to facilitate rotational movement and air is then directed downwards as illustrated by reference numeral 124.

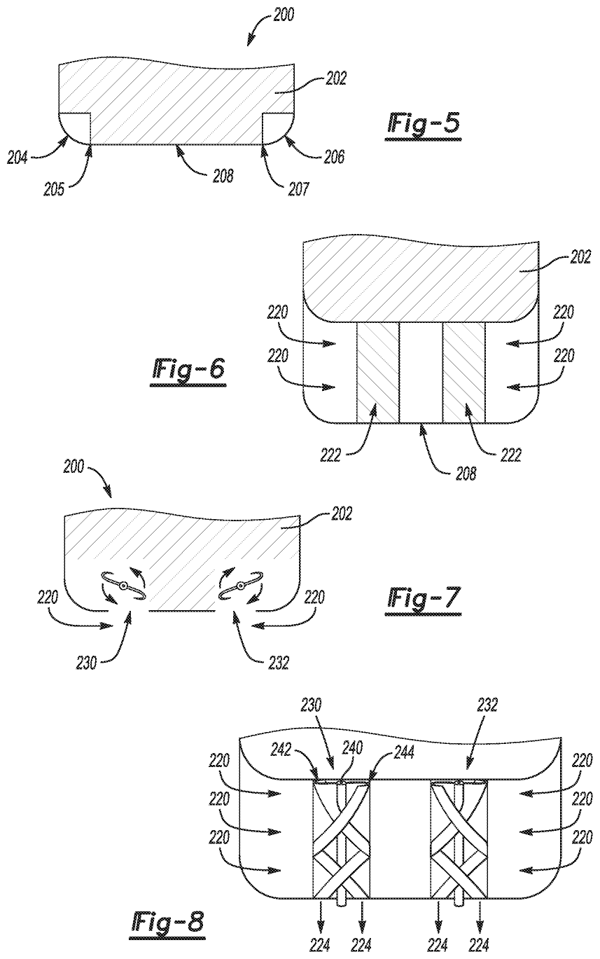

Referring now to FIGS. 5-8, an alternative system application is provided. In the apparatus and system as illustrated in FIGS. 5-8, the system 200 includes a vehicle 202 where the vehicle 202 is configured to hold the turbines 230, 232. The vehicle 202 of the system 200 includes curved edges 204, 206 adjacent a pair of openings 205, 207. Airflow 220 is directed around the edges or corners 204, 206 into the openings 205, 207. The turbines 230, 232 are positioned within the space of the vehicle adjacent to the openings 205, 207.

As in the prior embodiment, the outer surfaces may be smooth or textured so as to promote or otherwise direct airflow to the turbines 230, 232. Each of the turbines 230, 232 includes a central axis 240 and a pair of curved wing or blade members 242, 244. As air 220 moves and is directed around the corners 204, 206, it is directed to the turbines 230, 232 and then directed downwards, such as illustrated by reference number 224. The trailing edge 208 of the vehicle is located at the rear of the vehicle positioned adjacent to where the turbines 230, 232 are positioned.

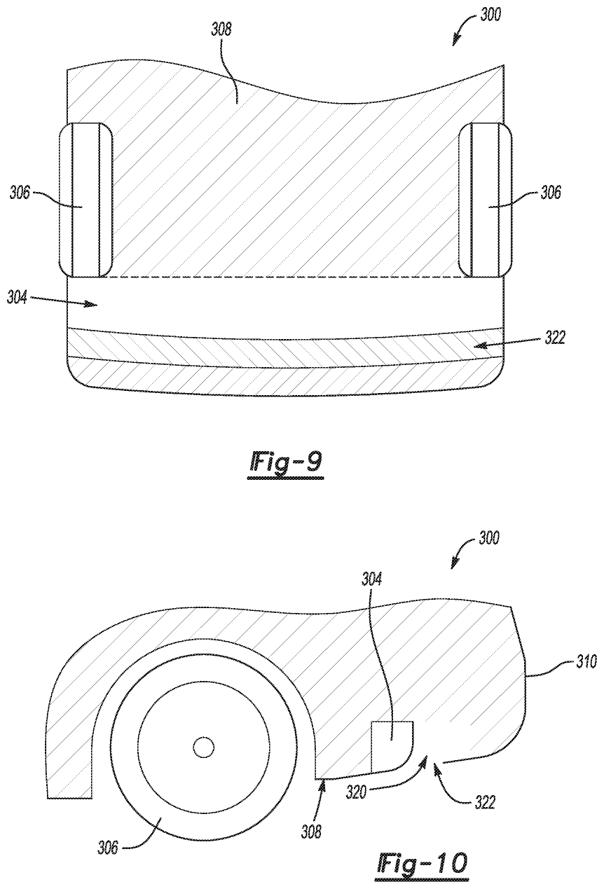

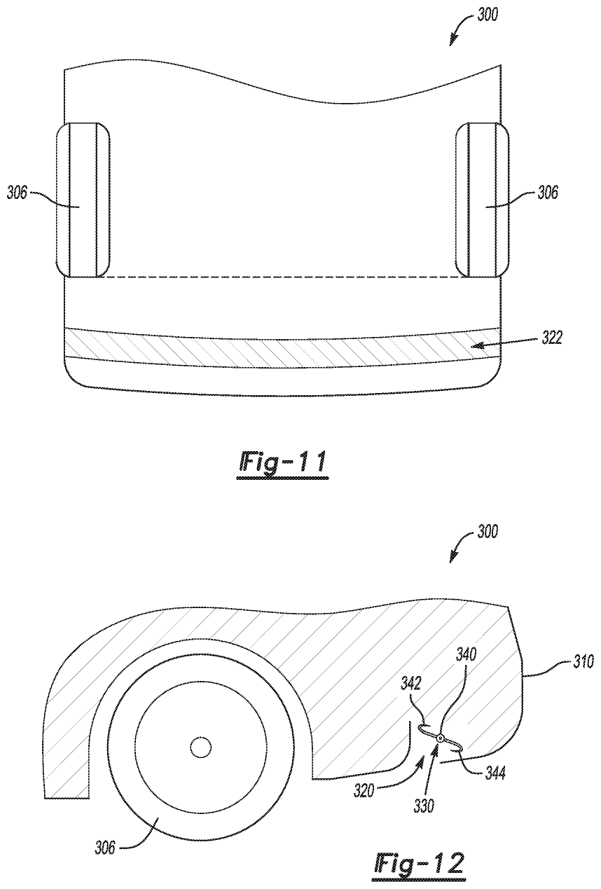

FIGS. 9-12 illustrate yet another alternative embodiment of the wind turbine system 300 as applied to a vehicle. The vehicle 308 includes a plurality of wheels 306 where the turbine system or turbine is placed towards the bottom of the vehicle to collect airflow from underneath the vehicle. The vehicle includes a curved portion 304 located adjacent to the turbine 330 where the curved portion 304 facilitates airflow 320 into the turbine 330.

The turbine 330 includes a central axis of rotation 340 and a pair of corresponding blades 342, 344. The vehicle 308 includes the curved surface 304 extending laterally across the vehicle 308. The vehicle 308 further includes an opening 322 so as to house the turbine 330. As the vehicle moves in a forward direction, airflow 320 moves along the bottom of the vehicle and along the curved surface 304 into the opening 322. Air then reaches the turbine 330 causing it to rotate and thus generate electricity to provide to the battery of the vehicle.

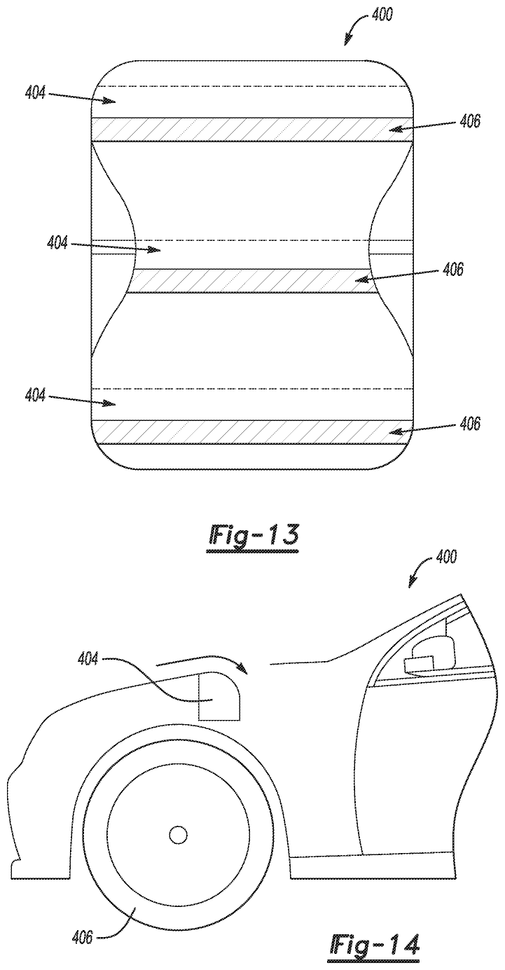

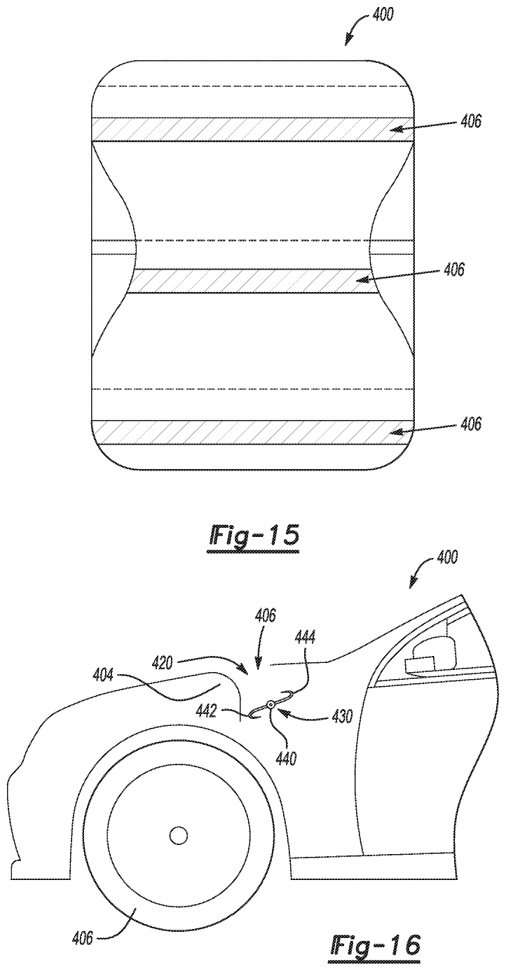

FIGS. 13-16 depict yet another alternative embodiment of the system 400 as applied to a vehicle. In this configuration, a plurality of openings 406 are positioned on the vehicle. Further, a plurality of curved surfaces 404 are also positioned on the vehicle so as to direct airflow 420 into the open areas 406. The vehicle contains at least one or a plurality of turbines 430 to capture the airflow 420 as the vehicle moves in a forward direction. As in prior embodiments, the turbine 430 includes a central axis of rotation 440 and a pair of corresponding blades 442, 444. In this embodiment, as in other embodiments, the vehicle includes a plurality of wheels 406 to propel the vehicle in a forward or rearward direction.

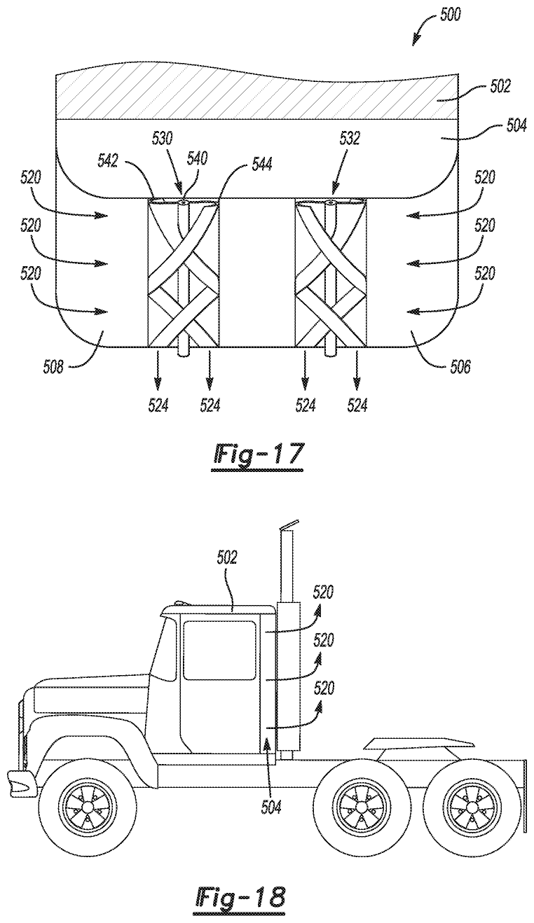

FIGS. 17 and 18 illustrate an alternative embodiment of the system 500 as applied to a semi-trailer truck. In this embodiment, the curved surfaces or housing holding the turbines is connected to the rear of a semi-trailer truck. The system 500 generally includes a housing 504 which is configured to connect directly to a truck 502. The housing 504 includes a pair of curved surfaces 506, 508. The curved surfaces 506, 508 are configured to direct airflow 520 into the turbines 530, 532 as illustrated by the plurality of arrows 520 in FIGS. 17 and 18. Each of the turbines 530, 532 also includes a central axis of rotation 540 and corresponding blades 542, 544. As airflow 520 moves into the turbines 530, 532 to rotate the turbines about the central axis 540, air is then displaced and moved downward as illustrated by reference numerals and corresponding arrows 524.

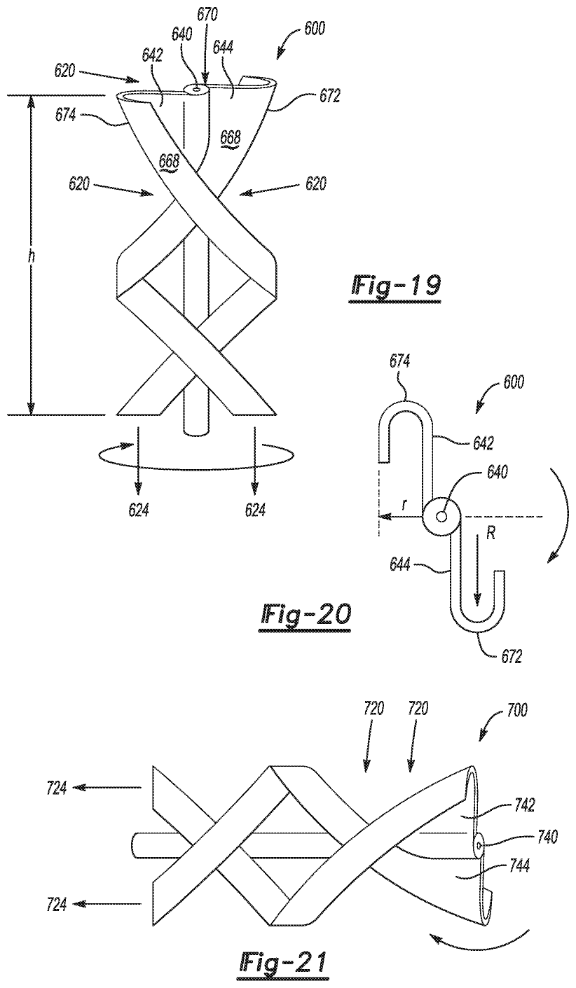

FIG. 19 depicts a singular twisted savonius wind turbine device as may be applied to any of the prior discussed embodiments. The turbine 600 generally includes a central axis of rotation 640 and a pair of corresponding twisted blades 642, 644, such as in all prior turbine systems shown herein. Each of the blades 642, 644 includes a distal end 672, 674. Each of the blades 642, 644 are twisted and have curved distal ends generally forming a helical configuration about each other. Each of the blades 642, 644 include an outer surface 668 which may be smooth or textured so as to facilitate airflow in a desired predetermined direction. In the embodiment as illustrated in FIG. 19, the turbine 600 rotates, by means of airflow 620, in a clockwise direction and pushes air downwards as illustrated and evidenced by reference numerals 624. Similarly, FIG. 20 depicts a top view of the turbine 600 better illustrating the curved portions 672, 674 of the blades 642, 644.

In alternative embodiments, a turbine 700 may be used either singular or in a plurality and arranged in a horizontal orientation. The wind turbine 700 also generally includes a central axis of rotation 740 and corresponding blades 742, 744. Airflow 720 is directed into the turbine and is directed and moved downwards as shown by reference numeral 724 so as to rotate the turbine.

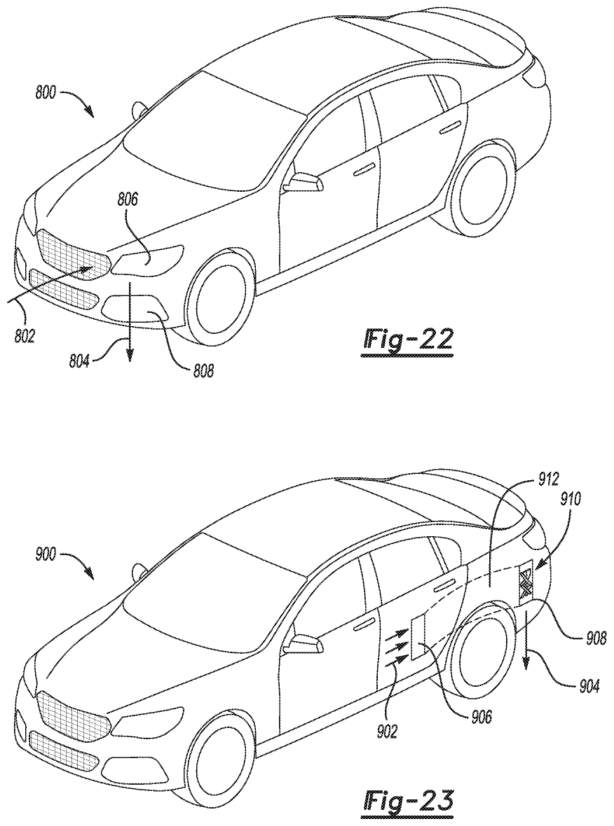

FIG. 22 depicts yet another embodiment of a savonius turbine and air flow director configuration on a vehicle 800. Air 802 moves into an opening 806 on a vehicle and thought (as illustrated by reference numeral 804) the air flow exit 808. An air flow director is positioned on a front corner of the vehicle. The air flow director having an opening and an exit so as to allow air to pass through while the vehicle is in motion. In this embodiment, the at least one savonius turbine is positioned within the opening.

In yet another embodiment as shown in FIG. 23, a vehicle 900 includes the air flow director and savonius turbine configuration positioned on the side of a vehicle. Air 902 moves into an opening 906 located on the side of the vehicle. Air moves through the savonius turbine 910 and cavity 908 and down (as shown by reference numeral 904). Air is configured to pass through the cavity 912 behind the outer body panel of the vehicle.

In each of these prior embodiments as discussed herein, materials used may be plastics, plastic-like materials, polymers, polymer-like materials, metals, alloys, and/or any other combination or alternative material having sufficient characteristics and properties to accomplish the functionality of the various systems as discussed herein. It should be appreciated that lightweight and highly resilient materials should be used as the system is applied to vehicles where strength and lightweight characteristics are required.

It should be appreciated that all of the systems discussed and disclosed herein are configured to enable an electric vehicle to operate for an extended duration as compared to using only the battery connected to the electric vehicle. All of the embodiments shown and described herein enable at least partial recharging of a vehicle when the vehicle is in motion.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for harnessing wind energy in a vehicle, the vehicle having a body, the system comprising:
at least one flow director connected to the vehicle; and
at least one savonius turbine connected to the vehicle, the at least one flow director configured to direct air towards the at least one savonius turbine, the at least one savonius turbine connected to an energy storage device;
wherein the savonius turbine harnesses wind energy created by a vehicle in motion, wherein movement of the savonius turbine generates power which is stored in the energy storage device.

2. The system for harnessing wind energy of claim 1 wherein two of the at least one savonius turbine are positioned at towards the rear of the vehicle, the savonius turbines positioned on opposed sides of the vehicle.

3. The system for harnessing wind energy of claim 2 wherein two of the at least one flow directors are positioned on outer opposed corners of the vehicle, an opening positioned in the body of the vehicle so as to direct air into a cavity so as to rotate the two of the at least one savonius turbines.

4. The system for harnessing wind energy of claim 1 wherein the at least one savonius turbine is positioned at the rear of a vehicle within and adjacent to an opening in the body of the vehicle.

5. The system for harnessing wind energy of claim 4 wherein the opening spans the width of the vehicle.

6. The system for harnessing wind energy of claim 4 wherein the flow direct is positioned adjacent the opening, the flow director positioned on an underside of the vehicle, the flow director spanning the width of the vehicle.

7. The system for harnessing wind energy of claim 6 wherein the at least one savonius turbine is positioned within the opening on the underside of the vehicle.

8. The system for harnessing wind energy of claim 1 wherein the flow director is positioned on or adjacent to the hood of the vehicle.

9. The system for harnessing wind energy of claim 8 wherein the air flow director spans the width of the vehicle.

10. The system for harnessing wind energy of claim 8 wherein an opening containing the at least one savonius turbine, the air flow director is configured to direct air from the vehicle in motion to the at least one savonius turbine positioned within the opening.

11. The system for harnessing wind energy of claim 1 wherein each of the at least one savonius turbines includes two spaced apart blades connected by a central axis of rotation, each of the blades including a curved distal end.

12. The system for harnessing wind energy of claim 11 wherein each of the at least savonius turbines is helical.

13. The system for harnessing wind energy of claim 1 wherein the air flow director is positioned on a front corner of the vehicle, the air flow director having an opening and an exit so as to allow air to pass through while the vehicle is in motion.

14. The system for harnessing wind energy of claim 13 wherein the at least one savonius turbine is positioned within the opening.

15. The system for harnessing wind energy of claim 1 wherein an opening is positioned on a side panel of a vehicle, the opening positioned forward of the vehicle tire.

16. The system for harnessing wind energy of claim 15 wherein a cavity is positioned above the vehicle tire, the at least one savonius turbine positioned rear of the vehicle tire and in fluid communication with the opening positioned forward of the tire.
